(19) United States
(12) Patent Application Publication
(10) Pub. No.: US 2025/0158801 A1
(43) Pub. Date: May 15, 2025

(54) DECOUPLED MULTI-PARTY REVERSIBLE DATA HIDING METHOD IN ENCRYPTED DOMAIN

(71) Applicant: Guangdong Polytechnic Normal University, Guangzhou City (CN)

(72) Inventors: Bing CHEN, Guangzhou City (CN); Ranran YANG, Guangzhou City (CN); Wanhan FANG, Guangzhou City (CN); Lu CHAI, Guangzhou City (CN); Yu ZHANG, Guangzhou City (CN); Jinghui PENG, Guangzhou City (CN); Qiuxia FAN, Guangzhou City (CN)

(21) Appl. No.: 18/747,692

(22) Filed: Jun. 19, 2024

(30) Foreign Application Priority Data
Nov. 10, 2023 (CN) 202311490599.7

(51) Int. Cl. H04L 9/00

(52) U.S. Cl. CPC H04L 9/008

(57) ABSTRACT

A decoupled multi-party reversible data hiding method in encrypted domain, comprises performing decoupled encryption on an original carrier to generate a plurality of encrypted carriers, where a preset number of arbitrary encrypted carriers contain all information of the original carrier, any single encrypted carrier contains only partial information of the original carrier, and the preset number is less than a total number of the encrypted carriers; embedding data into the encrypted carriers to obtain corresponding marked encrypted carriers; when the number of authorized marked encrypted carriers reaches the preset number, performing, by a current receiver, data extraction on the corresponding authorized marked encrypted carriers by using a data hiding key, to obtain the embedded data; and performing carrier recovery on the authorized marked encrypted carriers by using a decryption key to obtain the original carrier.

### CROSS REFERENCE TO RELATED APPLICATION

This patent application claims the benefit and priority of Chinese Patent Application No. 2023114905997, filed with the China National Intellectual Property Administration on Nov. 10, 2023, the disclosure of which is incorporated by reference herein in its entirety as part of the present application.

### TECHNICAL FIELD

The present disclosure relates to the technical field of data hiding, and in particular to a decoupled multi-party reversible data hiding method in encrypted domain.

### BACKGROUND

Reversible data hiding is a technique that embeds data into a carrier and performs data extraction and carrier recovery reversibly. With the increasing demand for privacy protection, reversible data hiding in encrypted domain has emerged. In this technique, a content owner encrypts a carrier and distributes the generated encrypted carrier to a data hider. The data hider then embeds data into the encrypted carrier to generate a marked encrypted carrier. A receiver extracts the embedded data and recovers the original carrier from the authorized marked encrypted carrier. Compared with reversible data hiding in encrypted domain, multi-party reversible data hiding in encrypted domain encrypts a carrier into multiple encrypted carriers and distributes them to different data hiders for data hiding. Multi-party reversible data hiding in encrypted domain ensures that even if some of the data hiders are damaged, enough marked encrypted carriers can be obtained from the undamaged data hiders for carrier recovery, thus further protecting the security of the original carrier.

Existing multi-party reversible data hiding in encrypted domain utilizes secret sharing to encrypt an original carrier into n(n≥2) encrypted carriers and distributes them to n data hiders. For the i(1≤i≤n)-th encrypted carrier, the corresponding data hider divides it into blocks having a size of n and embeds data into the i-th position of the blocks. To achieve the data embedding described above, a content owner needs to set specific parameters and embed them into the encrypted carriers to inform the data hiders about the embeddable positions. The existing technology has the following disadvantages: (1) Poor flexibility: Encrypted carriers generated based on secret sharing are highly coupled, and when one data hider embeds data in a certain position of the encrypted carrier, other data hiders cannot embed data in the corresponding positions, resulting in poor flexibility in data hiding. (2) Low embedding capacity: Only some of the elements in the encrypted carrier are used for embedding data, resulting in a limited amount of data embedded in the encrypted carrier and a low embedding capacity. This is especially true when a large number of encrypted carriers are generated. The number of elements available for data embedding in each carrier quickly decreases, further reducing the embedding capacity.

### SUMMARY

An objective of the present disclosure is to provide a decoupled multi-party reversible data hiding method in encrypted domain that can enhance the flexibility and embedding capacity of data hiding.

To achieve the above objective, the present disclosure provides the following technical solutions.

A decoupled multi-party reversible data hiding method in encrypted domain is provided, which is applied in a multi-party reversible data hiding model in encrypted domain. The multi-party reversible data hiding model in encrypted domain includes a content owner, a data hider, and a plurality of receivers.

The data hider includes a plurality of data sub-hiders.

All the data sub-hiders in the data hider are connected to the content owner.

Any one of the receivers is connected to a plurality of authorized data sub-hiders, where the authorized data sub-hiders are data sub-hiders authorized to the receiver in the data hider.

The method includes:
performing, by the content owner, decoupled encryption on an original carrier by using an encryption key to generate a plurality of encrypted carriers, and sending the plurality of encrypted carriers to corresponding data sub-hiders, where a preset number of arbitrary encrypted carriers contain all information of the original carrier, any single encrypted carrier contains only partial information of the original carrier, and the preset number is less than a total number of the encrypted carriers;
embedding, by the data sub-hiders, data to be hidden into the encrypted carriers using a data hiding key, to obtain corresponding marked encrypted carriers;
determining any one of the receivers as a current receiver;
sending, by the data hider, some of the marked encrypted carriers as authorized marked encrypted carriers to the current receiver;
extracting, by the current receiver, when the number of the authorized marked encrypted carriers reaches the preset number, embedded data from the preset number of the authorized marked encrypted carriers by using the data hiding key, where the embedded data is the same as the data to be hidden; and
performing, by the current receiver, carrier recovery on the authorized marked encrypted carriers by using a decryption key, to obtain the original carrier.

According to specific embodiments provided in the present disclosure, the present disclosure has the following technical effects:

The present disclosure provides a decoupled multi-party reversible data hiding method in encrypted domain applied in a multi-party reversible data hiding model in encrypted domain. The method includes: performing decoupled encryption on an original carrier to generate a plurality of encrypted carriers, where a preset number of arbitrary encrypted carriers contain all information of the original carrier, any single encrypted carrier contains only partial information of the original carrier, and the preset number is less than a total number of the encrypted carriers; embedding data into the encrypted carriers to obtain corresponding marked encrypted carriers; when the number of authorized marked encrypted carriers reaches the preset number, performing, by a current receiver, data extraction on the corresponding authorized marked encrypted carriers by using a data hiding key, to obtain the embedded data; and performing carrier recovery on the authorized marked encrypted carriers by using a decryption key to obtain the original carrier. The present disclosure utilizes a homomorphic encryption algorithm (e.g., Paillier additive homomorphic encryption, Elgamal multiplicative homomorphic encryption) to decouple shares generated by a secret sharing algorithm (e.g., Shamir secret sharing), allowing for unrestricted data embedding in encrypted carriers and enhancing the flexibility and embedding capacity of data hiding.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a decoupled multi-party reversible data hiding method in encrypted domain according to an embodiment of the present disclosure.

FIG. 2 is a flowchart illustrating principal steps associated with system and methodology depicted in FIG. 1.

FIG. 3 is a schematic block diagram of a computer architecture with components that can be used for implementing the method and the system according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a decoupled multi-party reversible data hiding method in encrypted domain that can enhance the flexibility and embedding capacity of data hiding.

In order to make the above objective, features and advantages of the present disclosure clearer and more comprehensible, the present disclosure will be further described in detail below in combination with accompanying drawings and particular implementation modes.

### Embodiment 1

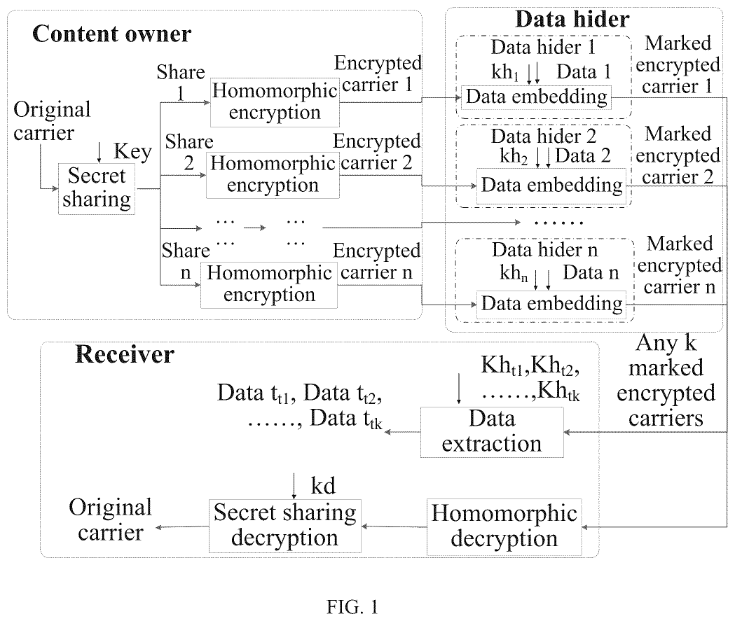

As shown in FIG. 1, this embodiment provides a decoupled multi-party reversible data hiding method in encrypted domain, which is applied in a multi-party reversible data hiding model in encrypted domain. The multi-party reversible data hiding model in encrypted domain includes a content owner, a data hider, and a plurality of receivers.

The data hider includes a plurality of data sub-hiders.

All the data sub-hiders in the data hider are connected to the content owner.

Any one of the receivers is connected to a plurality of authorized data sub-hiders, where the authorized data sub-hiders are data sub-hiders authorized to the receiver in the data hider.

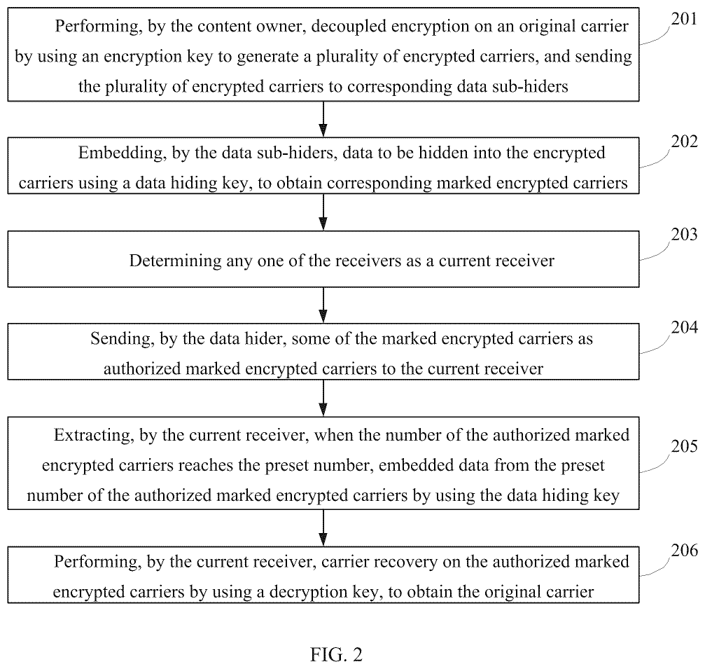

Referring to FIG. 1 in conjunction with the flowchart shown in FIG. 2, the method includes the following steps:

At step 201, the content owner performs decoupled encryption on an original carrier by using an encryption key to generate a plurality of encrypted carriers, and sends the plurality of encrypted carriers to corresponding data sub-hiders, where a preset number of arbitrary encrypted carriers contain all information of the original carrier, any single encrypted carrier contains only partial information of the original carrier, and the preset number is less than a total number of the encrypted carriers.

The data sub-hiders embed data (step 202) to be hidden into the encrypted carriers using a data hiding key, to obtain corresponding marked encrypted carriers.

Determine any one of the receivers as a current receiver (step 203).

The data hider sends some of the marked encrypted carriers as authorized marked encrypted carriers to the current receiver (step 204).

At step 205, when the number of the authorized marked encrypted carriers reaches the preset number, the current receiver extracts embedded data from the preset number of the authorized marked encrypted carriers by using the data hiding key, where the embedded data is the same as the data to be hidden.

The current receiver performs carrier recovery (step 206) on the authorized marked encrypted carriers by using a decryption key to obtain the original carrier.

The step of performing, by the content owner, decoupled encryption on an original carrier by using an encryption key to generate a plurality of encrypted carriers, and sending the plurality of encrypted carriers to corresponding data sub-hiders includes:
performing, by the content owner, secret sharing encryption on the original carrier by using the encryption key to generate a plurality of shares; and
performing, by the content owner, homomorphic encryption on the plurality of shares separately to obtain a plurality of encrypted carriers, and sending the encrypted carriers to the corresponding data sub-hiders.

The step of performing, by the current receiver, carrier recovery on the authorized marked encrypted carriers by using a decryption key to obtain the original carrier includes:
obtaining a plurality of authorized marked encrypted carriers, where the authorized marked encrypted carriers are obtained by embedding data into the encrypted carriers by using a data hiding key by authorized data sub-hiders and granting authorization to the current receiver, and the encrypted carriers are obtained by performing decoupled encryption on the original carrier with an encryption key by the content owner;
performing homomorphic decryption on the corresponding authorized marked encrypted carriers separately, to obtain a plurality of authorized shares; and
performing secret sharing decryption on the plurality of authorized shares by using the decryption key, to obtain the original carrier.

Before obtaining the plurality of authorized marked encrypted carriers, the method further includes the following steps:
determining whether the number of authorized data sub-hiders connected to the current receiver reaches the preset number;
if yes, performing the step of “obtaining a plurality of authorized marked encrypted carriers;” and
if not, sending an authorization request to the data hider.

The decoupled multi-party reversible data hiding method in encrypted domain provided in this embodiment includes three stages: a carrier encryption stage, a data embedding stage, and a data extraction and carrier recovery stage. In the carrier encryption stage, the content owner first uses an encryption key to perform secret sharing encryption on the original carrier to generate a plurality of shares, then apply homomorphic encryption to each share to generate corresponding encrypted carriers. In the data embedding stage, the data hider uses a data hiding key to embed data into the encrypted carriers, creating marked encrypted carriers. In the data extraction and carrier recovery stage, when a sufficient number of marked encrypted carriers are authorized to the receiver, the receiver first performs data extraction to retrieve the embedded data and then performs carrier recovery to obtain the original carrier. The specific technique is described as follows:

In the carrier encryption stage, the original carrier I is first encrypted into n(n≥2) shares using a secret sharing algorithm. Then, homomorphic encryption operations are performed on the generated n shares to obtain n encrypted carriers corresponding to the original carrier I, and each encrypted carrier is distributed to a corresponding data hider. For the original carrier I, the secret sharing process is expressed as follows:

Cᵢ=Shaₖₑ(I,Rs),i=1,2, . . . ,n (1)
where Shaₖₑ(*) represents a secret sharing algorithm using an encryption key ke, Rs represents a set of random numbers determined by the secret sharing algorithm, and Cᵢ represents the generated i-th share. Secret sharing involves encrypting the original carrier into a plurality of shares, such that each share can only access partial information of the original carrier, making the generated shares highly coupled. The present technology introduces homomorphic encryption to decouple the generated shares, expressed as follows:

Eᵢ=HE(Cᵢ,Rhᵢ),i=1,2, . . . ,n (2)
where HE(*) represents the homomorphic encryption algorithm, Rhᵢ represents a set of random numbers determined by the homomorphic encryption algorithm, and Eᵢ represents a generated encrypted carrier. Finally, the generated encrypted carrier Eᵢ is distributed to the i-th data hider for data embedding.

In the data embedding stage, the i-th data hider uses a data hiding key khᵢ,1≤i≤n to embed data into the encrypted carrier and generate a marked encrypted carrier. It is assumed that the data to be embedded by the i-th data hider is Dᵢ=0,1, . . . , 2^{T}−1,1≤i≤n, where T is the number of bits in Dᵢ. First, a set of random numbers Rh′ᵢ is selected according to the homomorphic encryption algorithm HE, and ciphertext HE (IEᵢ, Rh′ᵢ); corresponding to an identity element of the homomorphic encryption algorithm HE is calculated, where IEᵢ is the identity element of the homomorphic encryption algorithm HE. Then, a homomorphic operation is performed on the encrypted carrier Eᵢ and the generated identity element ciphertext HE (IEᵢ, Rh′ᵢ) to generate a marked encrypted carrier, that is:

EMᵢ=Eᵢ⊙HE(IEᵢ,Rh′ᵢ) (3)
where ⊙ represents the homomorphic operation, and a state of the generated marked encrypted carrier EMᵢ is equivalent to a state of Dᵢ.

Therefore, the data embedding process is expressed as follows:

EMᵢ=Embₖₕ_{ᵢ}(Eᵢ,Dᵢ) (4)
where Embₖₕ_{ᵢ}(*) represents a data embedding algorithm with the data hiding key khᵢ. For instance, if the encrypted carrier Eᵢ is odd and the embedded data Dᵢ is 0, Eᵢ is modified to be EMᵢ according to equation (3) so that EMᵢ is even.

In the data extraction and carrier recovery stage, once the receiver has collected a sufficient number of marked encrypted carriers, data extraction and carrier recovery can be performed. Data extraction can be achieved by examining the state of the marked encrypted carriers, which is expressed as follows:

Dₜ_{ⱼ}=Extₖₕₜ_{ⱼ}(EMₜ_{ⱼ}),1≤j≤k, (5)
where Extₖₕₜ_{ᵢ}(*) represents a data extraction algorithm with the data hiding key khᵢ(e.g., if EMᵢ is even, the extracted data Dᵢ is 0, and if EMᵢ is odd, the extracted data Dᵢ is 1.); EMₜ_{ⱼ} represents the tⱼ-th collected marked encrypted carrier; and Dₜ_{ⱼ} represents data extracted from the tⱼ-th collected marked encrypted carrier EMₜ_{ⱼ}, where {t₁, t₂ . . . , tₖ}⊆{1,2, . . . , n}.

For carrier recovery, the receiver first performs homomorphic decryption on each marked encrypted carrier to generate corresponding shares, and then performs secret sharing decryption on the generated k shares by using a decryption key kd to recover the original carrier. The carrier recovery process is expressed by the following formula:

$$\{ \begin{matrix}{C}_{i} = DHE ( {EM}_{i} ) \\ I = {DSha}_{kd} ( {C}_{{t}_{1}} , {C}_{{t}_{2}} , … , {C}_{{t}_{k}} )\end{matrix} \qquad ( 6 )$$

where DHE(*) represents the homomorphic decryption algorithm (e.g., Perier homomorphic decryption and Elgamal homomorphic decryption), DSha_{kd}(*) represents the secret sharing decryption algorithm with the decryption key kd Cₜ_{₁}, Cₜ_{₂}, . . . , Cₜ_{ₖ} are the k shares generated by homomorphic decryption, and {t₁, t₂ . . . , tₖ}⊆{1,2, . . . , n}.

The multi-party reversible data hiding method in encrypted domain provided in this embodiment not only retains the characteristic of the existing multi-party reversible data hiding model in encrypted domain where each data hider can only access a portion of the carrier information but also makes each data hider more flexible when performing data hiding operations. The decoupled encrypted carriers have more elements available for data embedding, which helps increase the embedding capacity.

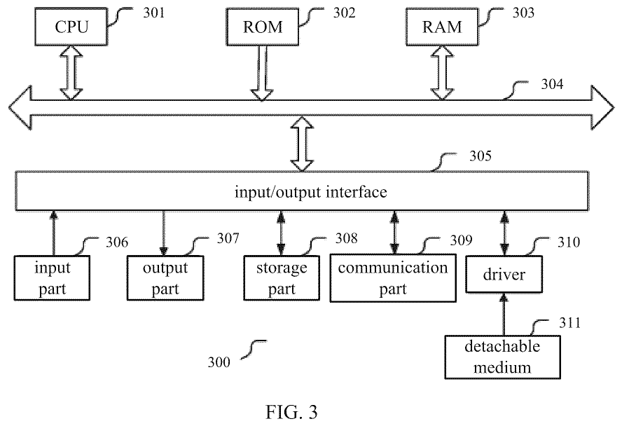

In addition, it should also be noted herein that the respective composite parts in the above system can be configured by software, firmware, hardwire or a combination thereof. Specific means or manners that can be used for the configuration will not be stated repeatedly herein since they are well-known to those skilled in the art. In case of implementation by software or firmware, programs constituting the software are installed from a storage medium or a network to a computer (e.g. the universal computer 300 as shown in FIG. 3) having a dedicated hardware structure; the computer, when installed with various programs, can implement various functions and the like.

FIG. 3 shows a schematic block diagram of a computer that can be used for implementing the method and the system according to the embodiments of the present disclosure.

In FIG. 3, a central processing unit (CPU) 301 executes various processing according to a program stored in a read-only memory (ROM) 302 or a program loaded from a storage part 308 to a random access memory (RAM) 303. In the RAM 303, data needed at the time of execution of various processing and the like by the CPU 301 is also stored according to requirements. The CPU 301, the ROM 302 and the RAM 303 are connected to each other via a bus 304. An input/output interface 305 is also connected to the bus 304.

The following components are connected to the input/output interface 305: an input part 306 (including a keyboard, a mouse and the like); an output part 307 (including a display, such as a Cathode Ray Tube (CRT), a Liquid Crystal Display (LCD) and the like, as well as a loudspeaker and the like); the storage part 308 (including a hard disc and the like); and a communication part 309 (including a network interface card such as an LAN card, a modem and so on). The communication part 309 performs communication processing via a network such as the Internet. According to requirements, a driver 310 may also be connected to the input/output interface 305. A detachable medium 311 such as a magnetic disc, an optical disc, a magnetic optical disc, a semiconductor memory and the like may be installed on the driver 310 according to requirements, such that a computer program read therefrom is installed in the storage part 308 according to requirements.

In the case of carrying out the foregoing series of processing by software, programs constituting the software are installed from a network such as the Internet or a storage medium such as the detachable medium 311.

Those skilled in the art should appreciate that such a storage medium is not limited to the detachable medium 311 storing therein a program and distributed separately from the apparatus to provide the program to a user as shown in FIG. 3. Examples of the detachable medium 311 include a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Or, the storage medium may be hard discs and the like included in the ROM 302 and the storage part 308 in which programs are stored, and are distributed concurrently with the apparatus including them to users.

The present disclosure further proposes a program product storing therein a machine-readable instruction code that, when read and executed by a machine, can implement the aforesaid method according to the embodiment of the present disclosure.

Correspondingly, a storage medium for carrying the program product storing therein the machine-readable instruction code is also included in the disclosure of the present disclosure. The storage medium includes but is not limited to a floppy disc, an optical disc, a magnetic optical disc, a memory card, a memory stick and the like.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the present description shall not be construed as a limitation to the present disclosure.

What is claimed is:

1. A decoupled multi-party reversible data hiding method in encrypted domain, applied in a multi-party reversible data hiding model in encrypted domain, wherein the multi-party reversible data hiding model in encrypted domain comprises a content owner, a data hider, and a plurality of receivers; wherein
the data hider comprises a plurality of data sub-hiders;
all the data sub-hiders in the data hider are connected to the content owner;
any one of the receivers is connected to a plurality of authorized data sub-hiders, wherein the authorized data sub-hiders are data sub-hiders authorized to the receiver in the data hider; and
wherein the method comprises:
performing, by the content owner, decoupled encryption on an original carrier by using an encryption key to generate a plurality of encrypted carriers, and sending the plurality of encrypted carriers to corresponding data sub-hiders, wherein a preset number of arbitrary encrypted carriers contain all information of the original carrier, any single encrypted carrier contains only partial information of the original carrier, and the preset number is less than a total number of the encrypted carriers;
embedding, by the data sub-hiders, data to be hidden into the encrypted carriers using a data hiding key, to obtain corresponding marked encrypted carriers;
determining any one of the receivers as a current receiver;
sending, by the data hider, some of the marked encrypted carriers as authorized marked encrypted carriers to the current receiver;
extracting, by the current receiver, when the number of the authorized marked encrypted carriers reaches the preset number, embedded data from the preset number of the authorized marked encrypted carriers by using the data hiding key, wherein the embedded data is the same as the data to be hidden; and
performing, by the current receiver, carrier recovery on the authorized marked encrypted carriers by using a decryption key, to obtain the original carrier.

2. The method according to claim 1, wherein said performing, by the content owner, decoupled encryption on an original carrier by using an encryption key to generate a plurality of encrypted carriers, and sending the plurality of encrypted carriers to corresponding data sub-hiders comprises:
performing, by the content owner, secret sharing encryption on the original carrier by using the encryption key to generate a plurality of shares; and
performing, by the content owner, homomorphic encryption on the plurality of shares separately to obtain a plurality of encrypted carriers, and sending the encrypted carriers to the corresponding data sub-hiders.

3. The method according to claim 1, wherein said performing, by the current receiver, carrier recovery on the authorized marked encrypted carriers by using a decryption key to obtain the original carrier comprises:
obtaining a plurality of authorized marked encrypted carriers, wherein the authorized marked encrypted carriers are obtained by embedding data into the encrypted carriers by using a data hiding key by authorized data sub-hiders and granting authorization to the current receiver, and the encrypted carriers are obtained by performing decoupled encryption on the original carrier with the encryption key by the content owner;
performing homomorphic decryption on the corresponding authorized marked encrypted carriers separately, to obtain a plurality of authorized shares; and
performing secret sharing decryption on the plurality of authorized shares by using the decryption key, to obtain the original carrier.

4. The method according to claim 3, wherein before obtaining the plurality of authorized marked encrypted carriers, the method further comprises:
determining whether the number of authorized data sub-hiders connected to the current receiver reaches the preset number;
if the number of authorized data sub-hiders connected to the current receiver has been determined to have reached the preset number, performing the step of obtaining said plurality of authorized marked encrypted carriers; and
if the number of authorized data sub-hiders connected to the current receiver has been determined not to have reached the preset number, sending an authorization request to the data hider.
